(19) United States
(12) Patent Application Publication
(10) Pub. No.: US 2012/0028060 A1
(43) Pub. Date: Feb. 2, 2012

(54) MULTILAYER BACKSHEET FOR PHOTOVOLTAIC MODULES, AND ITS PRODUCTION AND USE IN THE PRODUCTION OF PHOTOVOLTAIC MODULES

(75) Inventors: Dietmar ETZEL, Ennetbaden (CH); Mark PFLEGHAR, Domat/Ems (CH); Georg STOEPPELMANN, Bonaduz (CH); André STURZEL, Igis (CH)

(73) Assignee: EMS-PATENT AG, Domat/Ems (CH)

(21) Appl. No.: 13/187,129

(22) Filed: Jul. 20, 2011

(30) Foreign Application Priority Data
Jul. 30, 2010 (EP) 10171458.2
Mar. 24, 2011 (EP) 11159544.3

(51) Int. Cl. B32B 27/08; B29C 47/06

(52) U.S. Cl. 428/473.5; 428/475.2; 156/244.22; 156/244.17

(57) ABSTRACT

A multilayer backsheet (1) for a photovoltaic module according to the invention comprises a first outside layer (2), a second outside layer (3) and at least one inside layer (4, 5) which is arranged between these outside layers (2, 3). This at least one inside layer (4, 5) forms a water-vapor barrier and/or oxygen barrier. All these layers (2, 3, 4, 5) are composed of polymers. The multilayer backsheet (1) for a photovoltaic module according to the invention is characterized in that at least one of the two outside layers (2, 3) comprises a polyamide, and that the at least one inside layer (4, 5) consists of polymers which are no fluoropolymers and do not comprise any polyethylene. Inside layers (4, 5) made of partly aromatic polyesters are used only in combination with at least one outside adhesion promoter layer (6) made of block copolyesteramide.

The present application claims priority under 35 U.S.C. §119(a) of European Application No. 10171458.2 filed Jul. 30, 2010 and of European Application No. 11159544.3 filed Mar. 24, 2011, the disclosures of which are expressly incorporated by reference herein in their entireties.

The invention relates to photovoltaic modules, i.e. systems for photoelectric power generation. A single solar cell is arranged in such a substantially flat photovoltaic module, or a number of solar cells is combined and interconnected on a surface. According to the current state of the art, solar cells mostly consist of a semiconductor material which directly converts the incoming light into electric energy. Silicon is mainly used as the semiconductor material for this purpose. A large number of modules are switched in series in larger photovoltaic solar power plants, providing high voltage and high power of the installation.

It is known to replace the classic silicon material by thin layers, with the compound CuIn₁₋ₓGaₓSe₂ (CIGS) being regarded as one of the most promising materials for thin film solar cells with high efficiency in addition to CdTe (cadmium telluride) (cf. website of the EMPA, laboratory for thin films and photovoltaics). This EMPA Institute achieved efficiencies of up to 18.1% with CIGS on glass substrates. An efficiency of 17.6% was certified by the “Fraunhofer Institut für solare Energiesysteme” (ISE) in Freiburg (Germany) for flexible thin-film solar cells on polymer substrates. The processes for producing solar cells on polymer films can be adapted to the roll-to-roll production of monolithically switched solar modules. The use of organic semiconductors is also discussed (cf. Carsten Deibel, Thomas Strobel, Vladimir Dyakonov: Origin of the Efficient Polaron-Pair Dissociation in Polymer-Fullerene Blends. In: Physical Review Letters; Phys. Rev. Lett. 103, 036402, published on Jul. 16, 2009).

Highly efficient photovoltaic elements which contain metallic nanoparticles or nanostructures (each placed between an n-doped or p-doped charge transport layer) are known from US 2010/0000598 A1.

A photovoltaic module is usually arranged in a tabular manner as a laminate. A transparent pane made of special glass for example or a suitable transparent polymer or a transparent multilayer composite is arranged at the top. This is followed below by a film which preferably consists of ethylene vinyl acetate (EVA) and which connects or encapsulates the transparent pane with the actual solar cells (several silicon disks or also one single silicon disk) in order to prevent possible penetration of humidity. A further film made of EVA connects the bottom sides of the solar cells with a backsheet which represents the rear protective layer of the module. The connection of these layers is thermally solidified in a vacuum press (so that the layers will be glued together during hot pressing by way of the EVA). The layer materials are placed at first in reverse order in the press, so that the glass pane can act as a rigid base for the other layers during lamination. In this way the solar cells are embedded in the elastic and transparent EVA hot-melt adhesive and encapsulated between the glass and the backsheet, i.e. sealed against the entrance of humidity. In addition to the EVA polymer, further encapsulation materials are increasingly used such as PVB, TPU or silicon polymers. The backsheet of such a photovoltaic module is the main subject matter of the present invention.

A good description of this technological background is supplied by the international patent application WO 94/22172 A1. Tedlar® (a trademark of E. I. du Pont de Nemours and Company), which is a film made of polyvinyl fluoride (PVF), is mentioned there as the preferred backsheet. The Tedlar® backsheet is usually used in practice in form of a three-layer film (PVF/PET/PVF). WO 94/22172 A 1 discloses further thermoplastic materials such as polyolefines, polyesters, various polyamides (nylons), polyether ketones, fluoropolymers, etc as potential materials for the rear module layer.

The use of polyamide as encapsulation material for photovoltaic modules is the focus of the international patent application WO 2008/138021 A2. This document refers initially to the state of the art with multilayer film composites made of fluoropolymer and polyester (i.e. PVF and PET) as the (rear) encapsulation material. Since the adherence of this encapsulation material to the embedding material which is the ethylene vinyl acetate (EVA) is low, the patent application WO 2008/138021 A2 proposes polyamide (PA) as the encapsulation material, i.e. as the material for the use in backsheets of photovoltaic modules. Various types of polyamides are mentioned explicitly: PA 6, PA 66, PA 7, PA 9, PA 10, PA 11, PA 12, PA 69, PA 610, PA 612, PA 6-3-T, PA 61 and polyphthalamide (PPA). Document WO 2008/138021 A2 provides experimental proof for the use of the mentioned PA types neither for the use in a composite film nor as a monofilm.

Polyamide 11 is also mentioned as a possible backsheet material in the technical article “Bio Based Backsheet” by S. B. Levy which has been published in Proc. of SPIE (2008) Vol. 7048 (Reliability of Photovoltaic Cells, Modules, Components, and Systems), 70480C/1-10. In this article nylon 11 (i.e. PA 11) is regarded as a useful material for backsheets because it is based on a sustainable raw material source (castor oil). It is further disclosed that PA 11 still stable (i.e. it is not biodegradable) and is therefore of interest for the use in environmentally friendly generation of solar power. It is further disclosed that in practice the nylon 11 would not be used alone, but always in form of a composite with another film material (e.g. cellulose) as the backsheet.

US 2009/0101204 A1 also comes to the same conclusion, with S. B. Levy also be mentioned as its first inventor. In this case, the polyamide 11 (nylon-11 layer 510) is used in a composite with a special electrically insulating paper (505) as a photovoltaic backsheet (500) (cf. FIG. 5 and respective explanations). The polyamide 11 is applied by extrusion coating onto the paper.

WO 2008/138022 A1 also describes polyamide 12 as a layer material for protective films of photovoltaic modules and further indicates that respective film composites mainly consist of a carrier material layer chosen from polyester (PET or PEN) or fluoropolymer (ETFE).

Multilayer laminates are known from the state of the art as backsheets for photovoltaic modules. The Japanese patent application with the publication number JP 2004-223925 A discloses such a multilayer laminate for example which is resistant to humidity and penetration and is highly resistant to weathering. At least one first layer consists of a resin based on polypropylene (PP). A second layer consists of polyethylene (PE) which has a density of 0.94-0.97 g/cm³. Such a second layer is laminated onto one or both surfaces of the first layer.

A similar durability of a multilayer laminate is known from EP 1 956 660 A1. This multilayer laminate comprises a hydrolysis-resistant layer (made of a polyester resin with a carboxy end group content of not more than 15 equivalents per metric ton) and a layer of a PP resin which is laminated onto this hydrolysis-resistant layer. Alternative barrier layers made of metal oxide which are produced by means of PVD or CVD (physical or chemical vapor deposition) are also disclosed. Aluminum or silicon is used as a starting material for example.

Another strategy is pursued by U.S. Pat. No. 6,521,825 B2, in that a multilayer backsheet is provided which is light and thin, durable and offers improved resistance to humidity, and which is also a good electric insulator. This multilayer backsheet for photovoltaic modules comprises a middle layer which is resistant to humidity and which is arranged between two heat-resistant and weathering-resistant layers. The middle layer which is resistant to humidity comprises a layer made of an inorganic oxide which is deposited on the surface of a base layer.

A further strategy is pursued by WO 2009/085182 A2, in that a co-extruded multilayer backsheet is provided, comprising:
1) a first outside layer with a fluoropolymer (e.g. a polyvinylidene fluoride=PVDF),
2) an inside layer which comprises a polyester or a polycarbonate (or combinations of the same) and a phase agent on the basis of acrylic or methacrylic or on the basis of an alkaline tin oxide, and which
3) comprises a second outside layer with a fluoropolymer, a polyolefin or a polyolefin hot-melt adhesive.

Further multilayer backsheets for photovoltaic modules on the basis of PVDF are further known from the documents WO 94/22172 A1, WO 2008/157159 A1 for example. In this connection WO 2008/157159 A1 discloses that layers made of aluminum, polyethylene terephthalate (PET), polyethylene naphthalate (PEN) or ethylene vinyl alcohol copolymer (EVOH) can be used in combination with fluoropolymer layers as suitable barriers against vapor. In contrast to this, WO 2009/067422 A1 and WO 2009/111194 A1 disclose layers on the basis of PVDF as a glass substitute for mounting on the side of the solar cell that is subjected to the light.

A solar cell with a side facing the light and a rear side is known from WO 2008/097660 A1. The solar cell further comprises a rigid encasing layer made of polyvinyl butyral (PVB) which is adjacent to the side facing the light or the rear side of the solar cell and has a PVB composition which comprises 10 to 23% by weight of plasticizers measured on the total weight of the PVB composition and which encases the solar cell in a polymer matrix comprising the PVB composition. Further multilayer backsheets for photovoltaic modules on the basis of PVB are further known from the document WO 2008/138022 A1 for example.

A polyolefin grafted with polyamide which comprises reactive side groups is known as a further possible material for a protective backsheet in photovoltaic modules from WO 2010/069546 A2.

It was noticed in single-layer backsheets for photovoltaic modules made from various polyamides (PA 12, PA 1010, PA 610, PA 612 or PA MACM12), i.e. in mono backsheets for photovoltaic modules which are made from these polyamides, that polyamides tend to turn yellow relatively quickly at temperatures of 80° C. and more. In the case of backsheets made from such polyamides the desired property of the film to reflect light will thus tend to decrease. If the film is removed from the influence of oxygen, this yellowing can be reduced considerably. It is further known that the electric components of the photovoltaic modules are sensitive to humidity. In permanent operation in a humid climate the ability of the photovoltaic modules to operate will decrease considerably when water vapor penetrates through the material of the backsheets of the photovoltaic modules.

The present invention is therefore based on the object of providing an alternative multilayer backsheet for photovoltaic modules with improved water-vapor and oxygen barrier effect.

This object is achieved according to a first aspect by a multilayer backsheet for a photovoltaic module with the features of claim 1. This multilayer backsheet for a photovoltaic module comprises a first outside layer, a second outside layer and at least one inside layer arranged between these outside layers and forming a water-vapor barrier and/or an oxygen barrier, with these layers being made of polymers. The multilayer backsheet for a photovoltaic module in accordance with the invention is characterized in that at least one of the two outsides layers comprises a polyamide. The at least one inside layer consists of polymers which are no fluoropolymers and do not comprise any polyethylene. Inside layers made of partly aromatic polyesters are always connected by means of at least one outer adhesion promoter layer made of a block copolyesteramide with at least one of the outside layers comprising a polyamide.

This object is achieved according to a second aspect by a method for producing a multilayer backsheet for a photovoltaic module with the features of claim 17. This multilayer backsheet for a photovoltaic module comprises a first outside layer, a second outside layer and at least one inside layer arranged between these outside layers and forming a water-vapor barrier and/or an oxygen barrier, with these layers being made of polymers. The method in accordance with the invention for producing a multilayer backsheet for a photovoltaic module is characterized in that at least one of the two outside layers is formed by a polyamide and that the at least one inside layer is formed by a polymer which is no fluoropolymer and does not comprise any polyethylene. Inside layers made of partly aromatic polyesters are always used in combination with an outer adhesion promoter layer made of a block copolyesteramide.

Further preferred features of the multilayer backsheet for a photovoltaic module in accordance with the invention or the method in accordance with the invention for producing a multilayer backsheet for a photovoltaic module are provided in the respectively dependent claims. The use of such a multilayer backsheet for a photovoltaic module or a method for their production preferably occurs during the production of photovoltaic modules.

The following definitions will be mentioned in connection with the present invention:

The term “polyamide” shall be understood to include the following:

Homopolyamides and

Copolyamides.

The term “polyamide blends” shall be understood to include the following:

Mixtures (blends) of homopolyamides and copolyamides;

Mixtures of homopolyamides, and

Mixtures of copolyamides.

The term “polyamide molding compound” shall relate to a molding compound which contains the polyamides and/or polyamide blends, wherein such polyamide molding compound may contain additives.

The advantages of the present invention are as follows:
1. In a preferred embodiment of the multilayer backsheet for photovoltaic modules in accordance with the invention, an inside layer made of PVDC protects the adjacent polyamide outside layer (and thus also the electric components of the solar cells) especially from the entry of water vapor, and this polyamide layer also from entry of atmospheric oxygen and thus from yellowing.
2. In a preferred embodiment of the multilayer backsheet for photovoltaic modules in accordance with the invention, an inside layer made of EVOH protects the polyamide outside layer closest to the solar cells especially from entry of atmospheric oxygen.
3. In an especially preferred embodiment of the multilayer backsheet for photovoltaic modules in accordance with the invention, an inside layer made of PVDC and an inside layer made of EVOH provide improved protection against entry of water vapor and atmospheric oxygen for the polyamide outside layer closest to the solar cells and the solar cells as such.
4. In an alternative preferred embodiment of the multilayer backsheet for photovoltaic modules in accordance with the invention, an inside layer made of COC and an inside layer made of EVOH provide improved protection against the entry of water vapor and atmospheric oxygen for the polyamide outside layer closest to the solar cells and the solar cells as such.
5. In a preferred and especially cost-effective embodiment of the multilayer backsheet for photovoltaic modules in accordance with the invention, an inside layer made of PP and an inside layer made of EVOH provide improved protection against the entry of water vapor and atmospheric oxygen for the polyamide outside layer closest to the solar cells and the solar cells as such.
6. The multilayer backsheets for photovoltaic modules in accordance with the invention effectively prevent yellowing of the polyamide outside layer closest to the solar cells (especially by the increased blocking effect against atmospheric oxygen), which polyamide outside layer therefore fully retains its property as a white reflective layer behind the solar cells, thus keeping the electric yield of the solar cells at a high level.
7. The multilayer backsheets for photovoltaic modules in accordance with the invention effectively ensure that the polyamide outside layer closest to the solar cells fully retains its property as an electric insulating layer (especially by the increased blocking effect against water vapor), and thus the operating capability of the electrical components is not impaired by potential short-circuit currents.
8. When using a barrier layer made of a partly aromatic polyester in combination with a block copolyesteramide as an adhesion promoter layer to the outside layer or layers made of polyamide, such a multilayer backsheet for photovoltaic modules in accordance with the invention can be produced very economically in one step by co-extrusion because the lamination of individual films by means of adhesives can be omitted.

It needs to be noted at this point for the purpose of better understanding that the outside layer of the multilayer backsheet which is closest to or faces the solar cells obviously does not represent any outside layer any more but an intermediate layer after joining the other parts in the thermal vacuum press, as seen in the finished and completed photovoltaic module.

The enclosed drawings represent preferred embodiments of the present invention and are used merely for their illustration and not for limiting the scope of the invention, wherein:

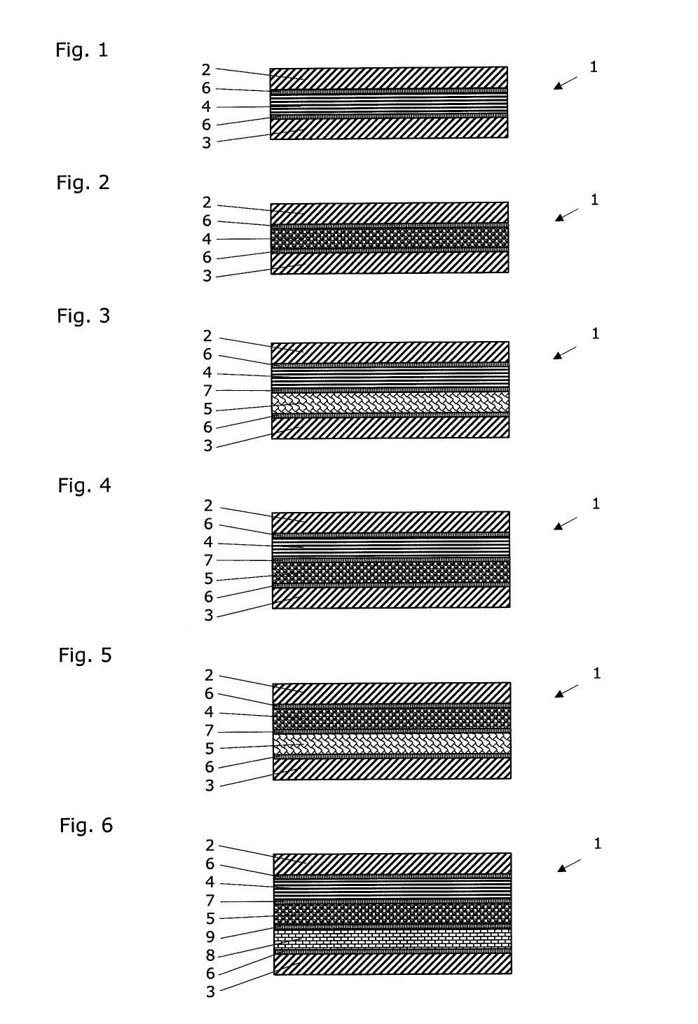

FIG. 1 shows a multilayer backsheet for a photovoltaic module with two outside layers and one inside layer, according to a first embodiment;

FIG. 2 shows a multilayer backsheet for a photovoltaic module with two outside layers and one inside layer, according to a second embodiment;

FIG. 3 shows a multilayer backsheet for a photovoltaic module with two outside layers and two inside layers, according to a third embodiment;

FIG. 4 shows a multilayer backsheet for a photovoltaic module with two outside layers and two inside layers, according to a fourth embodiment;

FIG. 5 shows a multilayer backsheet for a photovoltaic module with two outside layers and two inside layers, according to a fifth embodiment;

FIG. 6 shows a multilayer backsheet for a photovoltaic module with two outside layers and three inside layers, according to a sixth embodiment.

FIG. 1 shows a multilayer backsheet 1 for a photovoltaic module which comprises a first outside layer 2, a second outside layer 3 and an inside layer 4 which is disposed between said outside layers 2, 3 and forms a water-vapor barrier and/or an oxygen barrier, with said layers being made of polymers. At least one of the two outsides layers 2, 3, preferably both outside layers 2, 3, comprise a polyamide, with both outside layers 2, 3 consisting of the same polyamide in an especially preferred variant of this first embodiment.

At least the outside layer of the backsheet closest to the solar cells can be transparent, so that an inside layer disposed beneath the same can be arranged as a reflective layer in that it contains a white pigment. Preferably, a reflectivity of at least 92% or more is provided, with the white pigment preferably being titanium dioxide. The outside layer of the backsheet which is closest to the solar cells can also be arranged alternatively or preferably as a reflective layer and contain a white pigment (preferably titanium dioxide) which preferably provides a reflectivity of at least 92%.

Transparent polyamides are made of aliphatic, cycloaliphatic and/or aromatic monomers and comprise both homopolyamides and copolyamides. Both amorphous as well as micro-crystalline polyamides are transparent. Microcrystalline polyamides are no longer completely amorphous, but they comprise crystallites on the basis of their microcrystalline structure which are smaller than the wavelength of light and are therefore not visible. Microcrystalline polyamides are therefore still transparent to the eye. Especially preferred transparent polyamides are homopolyamides such as PA MACM12 and PA PACM12 as well as the copolyamides PA 12/MACMI, PA MACM12/PACM12 and PA MACMI/MACMT/12, and mixtures or blends of these polyamides.

Preferably, the polyamide for at least one outside layer or both outside layers 2, 3 concerns polyamides composed on the basis of linear and/or branched aliphatic and/or cycloaliphatic and/or aromatic monomers chosen from the group of diamines, dicarboxylic acids, lactams and amino carboxylic acids, such as PA 11, PA 12, PA 610, PA 612, PA 1010, PA 1012, PA 106, PA 106/10T, PA 614, PA 618 and PA MACM12 or mixtures thereof, and the previously mentioned group of the transparent polyamides. The following polyamides are also preferred for producing the outside layers 2, 3: PA 6, PA 66, PA 7, PA 9, PA 10, PA 69, PA 6-3-T, PA 61, polyphthalamide (PPA) and other potential aromatic or partly aromatic polyamides and copolyamides of all these types.

The monomers chosen for the polyamide comprise on average at least 6 and a maximum of 17 C atoms (i.e. individual monomers can comprise less than 6 C atoms, if on the other hand the other monomers contained in the polymer comprise respectively more than 6 C atoms). Due to the fact that the monomers chosen for the polyamide comprise on average at least 6 and a maximum of 17 C atoms, the selection range for the individual monomers will be extended downwardly (compared with the stricter condition that each monomer contained in the polyamide should have at least 6 C atoms) and is based on the consideration that optionally short monomers (e.g. short-chain diamines) can thus be compensated or overcompensated with long monomers of the other type (e.g. long-chain dicarboxylic acids) in the same polyamide, so that the average results in at least 6 C atoms (and a maximum of 17 C atoms). One example for a polyamide in which the average requirement is fulfilled but not every monomer comprises at least 6 C atoms is PA 412, which is made of the 4C-diamine butane diamine and the 12C-dicarboxylic acid dodecanedioic acid.

The monomers are chosen from the group consisting of diamines, dicarboxylic acids, lactams and amino carboxylic acids, and mixtures thereof. The polyamides based on lactams and amino carboxylic acids are preferably cross-linked. The polyamides of the mentioned area which are based on diamines and dicarboxylic acids represent preferred variants both in uncross-linked and also in cross-linked form. Although the polyamide could still be uncross-linked in a further variant, it could already contain a cross-linkage activator such as TAIC for example which would lead to cross-linking in the case of a fire and would prevent dripping of polyamide.

As was already mentioned, the polyamide can also contain cycloaliphatic monomers in addition to aliphatic monomers, of which the following are preferred: CHDA (abbreviation for the cycloaliphatic monomer compound of cyclohexane dicarboxylic acid, with the 1,4-CHDA being referred to), BAC (abbreviation for bisaminocyclohexane), PACM (=4,4′-diaminodicyclohexyl methane), MACM (=3,3′-dimethyl-4,4′-diaminodicyclohexylmethane), and mixtures of the cycloaliphatic diamines.

In the preferred embodiments the polyamide is chosen from the group of polyamide 4X (X=linear aliphatic dicarboxylic acid with 12 to 18 C atoms), polyamide 4X cross-linked, polyamide 9 cross-linked, polyamide 99, polyamide 99 cross-linked, polyamide 910, polyamide 910 cross-linked, polyamide 1010, polyamide 1010 cross-linked, polyamide 11 cross-linked, polyamide 12 cross-linked, polyamide 1010/10CHDA, polyamide 1010/10CHDA cross-linked, polyamide 610/10CHDA, polyamide 610/10CHDA cross-linked, polyamide 612/10CHDA, polyamide 612/10CHDA cross-linked, polyamide 910/10CHDA, polyamide 910/10CHDA cross-linked, polyamide 912/10CHDA, polyamide 912/10CHDA cross-linked, polyamide 1012/10CHDA, polyamide 1012/10CHDA cross-linked, polyamide 610/12CHDA, polyamide 610/12CHDA cross-linked, polyamide 612/12CHDA, polyamide 612/12CHDA cross-linked, polyamide 910/12CHDA, polyamide 910/12CHDA cross-linked, polyamide 912/12CHDA, polyamide 912/12CHDA cross-linked, polyamide 1012/12CHDA, polyamide 1012/12CHDA cross-linked, polyamide 1212/12CHDA, polyamide 1212/12CHDA cross-linked, polyamide 1212/10CHDA, polyamide 1212/10CHDA cross-linked, polyamide 1012, polyamide 1012 cross-linked, polyamide 1014, polyamide 1014 cross-linked, polyamide 1212, polyamide 1212 cross-linked, polyamide 1210, polyamide 1210 cross-linked, polyamide MACMY (Y=linear aliphatic dicarboxylic acid with 9 to 18 C atoms), polyamide MACMY cross-linked, polyamide PACMY, polyamide PACMY cross-linked, polyamide MACMY/PACMY, polyamide MACMY/PACMY cross-linked, and mixtures thereof. The polyamide is especially preferably chosen from the group of polyamide 1010 and polyamide 1010 cross-linked as well as polyamide 12 cross-linked. Furthermore, the two outside layers 2, 3 can comprise different polyamides and/or polyamide blends (see Table 1).

The at least one inside layer 4, 5 consists of a polymer that is no fluoropolymer, with polyethylene further being excluded as an inside layer. Polymers with barrier properties against water vapor and/or oxygen are preferred for the inside layer. Preferred polymers for the at least one inside layer 4, 5 are mentioned on the one hand in the dependent claim 5 and on the other hand in the dependent claim 10. If partly aromatic polyesters are chosen as the barrier polymer for the inside layer according to claim 1 or claim 10, these polyesters are exclusively used in combination with at least one adhesion promoting layer made of a block copolyesteramide in the multilayer backsheets 14 for photovoltaic modules in accordance with the invention. Such a combination of polyester with a block copolyesteramide adhesion promoter is not anticipated by WO 2008/138022 A1.

An especially preferred material for the at least one inside layer 4, 5 is polyvinylidene chloride (PVDC). Such a PVDC material is known under the trade name IXAN® PV 910 (SolVin S.A., B-1120 Brussels, Belgium). It concerns a PVDC blend with 2% epoxidized soybean oil which is suitable for the extrusion and co-extrusion of films (with EVA or PE) for packaging foodstuffs. These films can be heat-shrink films or heat-deformable films, among other things. The material has a melting temperature of 155° C. and a low permeability for water vapor and oxygen.

It is known that close to the processing temperatures for compact PVDC (160° C. to 170° C.) the decomposition of the material commences under the elimination of HCl, so that processing machines can be considerably damaged by corrosion during the extrusion. That is why preferably copolymers made of PVDC with vinyl chloride (5 to 20%) or with vinyl chloride (13%) and acrylonitrile (2%) are processed. In order to allow the manufacturer of a multilayer film to avoid the (co-)extrusion of PVDC, the lamination of the two outside layers 2, 3 onto the at least one inside layer 4, 5 of PVDC is especially preferred in form of an already provided PVDC film. An alternative possibility would be applying PVDC as a suspension to an outside layer film.

Cyclic olefin copolymers (COC) can be considered as an alternative material for the at least one inside layer 4, 5. Cyclic olefin copolymers (COC, trademark TOPAS®; Topas Advanced Polymers GmbH, D-95926 Frankfurt, Germany) are known to have outstanding water-repellent properties and represent a very good water-vapor barrier. As a result of its olefinic character, COC products are resistant towards hydrolysis, acids and alkaline solutions and towards polar solvents such as methanol. However, COC products can be damaged by non-polar organic solvents such as toluol for example. Since TOPAS® COC resins are sensitive to ultraviolet radiation, the use of UV stabilizers is recommended. COC functionalized with maleic anhydride is preferably used when using COC inside layers for the purpose of achieving better adhesion.

EVOH is considered as a further alternative material for the at least one inside layer 4, 5, especially due to the excellent oxygen barrier. Moreover, polypropylene (PP) is considered as a further material for the at least one inside layer 4, 5 because it provides a relatively good water-vapor barrier (cf. Table 2) and is therefore especially suitable for combination with an EVOH layer (cf. Table 1). The polyethylene (PE) known from JP 2004-223925 A is not considered for the at least one inside layer 4, 5 in the present invention despite the fact that it offers a good water-vapor barrier, because its melting point of 135° C. is too low for the production of the finished photovoltaic modules because temperatures in the magnitude of 140 to 150° C. are generally used in the vacuum press for laminating the entire module.

The material for the at least one inside layer 4, 5 is therefore preferably chosen from a group which comprises PVDC, COC, PP and EVOH, and combinations thereof. Additional preferred materials for the at least one inside layer which are also comprised by this group are PPS (polyphenylene sulfide), PSU (polysulfone), PESU (polyether sulfone), PPSU (polyphenyl sulfone), PEEK (polyether ether ketone), liquid crystalline polymers (LCP=liquid crystalline polymers), polyimide (PI) and polyamideimide (PAI). Preferred combinations for the two inside layers 4, 5 can be formed from PVDC+EVOH or COC+EVOH or PP+EVOH, with the combination of PVDC+EVOH being especially preferred.

An adhesion promoter layer 6 can be arranged for better adhesion of the layers among each other between at least one surface of the inside layer 4, 5 and an inner surface of one or both outside layers 2, 3. This is only necessary however if both outside layers 2, 3 will not enter into any spontaneous adhesive connection with the inside layer 4, 5 as a result of the material. Similarly, an adhesion promoter layer 7 can also be provided between two inside layers 4, 5. The material for the adhesion promoter layers 6, 7, 9 is preferably chosen from the group which comprises the acrylates, epoxides, PUR (polyurethane), functionalized polyolefins (e.g. on the basis of EPM or EPDM), ionomers and ethylene vinyl acetate (EVA).

In an alternative variant of the multilayer backsheet 1 for photovoltaic modules according to the invention, the material for the at least one inside layer 4, 5 is chosen from a group of partly aromatic polyesters which comprises PBT (polybutylene terephthalate), PET (polyethylene terephthalate) and PEN (polyethylene naphthalate). This inside layer is always combined with at least one adjacent adhesion promoter layer made of block copolyesteramide with blocks compatible with the adjacent layers, which copolyesteramide connects the partly aromatic polyester layer with at least one polyamide outside layer.

Preferably, the blocks of the block copolyesteramide correspond to the partly aromatic polyester on the one hand and the polyamide on the other hand, to which the adhesion promoter layer made of block copolyesteramide is adjacent, because materially identical blocks with respect to the adjacent polymer layer produce the best compatibility or adhesion.

In a preferred embodiment the partly aromatic polyester layer is connected on both sides by a respective adhesion promoter layer made of block copolyesteramide with two outside layers 2, 3 made of polyamide.

The use of a block copolyesteramide as an adhesion promoter layer allows producing a finished backsheet in one step by co-extrusion, i.e. such a multilayer backsheet for a photovoltaic module is preferably co-extruded.

An advantageous multilayer backsheet for photovoltaic modules with an inside layer made of a partly aromatic polyester and block copolyesteramide as an adhesion promoter (HV) can have the following structure for example: polyamide 12/HV/PBT/HV/polyamide 12. In this case the block copolyesteramide adhesion promoter is preferably composed of polyamide 12 and PBT blocks. Such an adhesion promoter can be obtained under the name Grilamid® EA20HV1 from EMS-CHEMIE AG (Domat/Ems, Switzerland).

Preferable is also the analog structure of a multilayer backsheet for photovoltaic modules with an inside layer made of a partly aromatic polyester and block copolyesteramide as an adhesion promoter, in which PA 1010 forms the polyamide outside layers: polyamide 1010/HV/PBT/HV/polyamide 1010.

In a method for producing a multilayer backsheet 1 for photovoltaic modules in accordance with the invention, a cross-linking activator can be added to a polyamide melt for achieving cross-linking of the polyamide. The cross-linking activator is preferably chosen from the group of trimethylol propane trimethacrylate and triallyl isocyanurate (TAIC).

Preferably, the two outside layers 2, 3 are extruded at first as separate films and are laminated onto the two surfaces of the inside layer 4. Alternatively, the two outside layers 2, 3 and the inside layer 4 can be co-extruded as melt layers directly into a multilayer film. As was already mentioned, the latter is especially preferred particularly in the case of partly aromatic polyester in combination with block copolyesteramide.

If a cross-linking activator is contained in the polyamide, cross-linking on the extruded foils can be triggered preferably by high-energy radiation, e.g. by electron radiation, either on the separate individual polyamide films or on the multilayer film.

The variant of a cross-linkable but not yet cross-linked polyamide is provided with a cross-linking activator but without radiation. Such a variant is useful if cross-linking is not required in the normal state with respect to the properties but where the dripping of polyamide is to be prevented in an emergency such as a fire. The cross-linking will be triggered in this event especially by the thermal energy of the fire.

The polyamide molding compound of the backsheet in accordance with the invention preferably comprises an additive chosen from white pigments, UV stabilizers, UV absorbers, antioxidant agents, heat stabilizers, hydrolysis stabilizers, cross-linking activators, flame retardants, nanofillers such as especially layered silicates, fillers, colorants (comprising dyes and color pigments), reinforcing agents, adhesion promoters and impact modifiers. The water-vapor barrier of the polyamide material or the backsheet can further be improved with layered silicates. Layered silicates further improve the thermo-oxidative durability of the polyamide molding compound and improve the dimensional stability (lower aftershrinkage during production of the film and lower coefficient of thermal expansion).

The white pigment which offers the desired high reflectivity preferably concerns titanium dioxide (preferably in the rutile crystal modification). Titanium dioxide also acts simultaneously as a UV absorber. Other possible white pigments are zinc oxide and zinc sulfide for example. Reflectivity of the backsheet achieved with white pigments is preferably at least 92%.

It is desirable if backsheets for photovoltaic modules further fulfill certain requirements concerning the behavior during a fire and the spreading of fires, as has been described for example in the US standard UL 790 (Standard Test Methods for Fire Tests of Roof Coverings). The backsheets need not necessarily be flame resistant, but if possible these polymers or polyamides should at least not drip or fall into a flame or when they burn themselves, because burning drops can quickly spread a fire to the lower levels of a house. The inventors have noticed concerning dripping that cross-linked polyamides will virtually not drip upon contact with a flame in contrast to normal, uncross-linked polyamides. In addition or alternatively, the polymers or polyamides can contain flame retardants and can thus be arranged in a flame-retardant manner. The cross-linked polyamides PA 1010 and PA 12 are especially preferred under these aspects. Additional flame retardants are optionally also possible. Flame retardants can be incorporated in several layers.

By choosing the polyamide from the claimed area for the outside layers 2, 3 and the material for the at least one inside layer 4, 5 and the optional addition of one or several of these additives, the multilayer backsheet 1 for photovoltaic modules in accordance with the invention meets all relevant requirements placed on such a backsheet such as weathering stability (UV and hydrolysis resistance), heat resistance, mechanical protection, electric insulation, high reflectivity and good adhesion. In such a multilayer solution in accordance with the invention with one (or several) chosen inside layer(s), the improvement in the water-vapor and oxygen barrier, the reduction in the thermal expansion between −30° C. and +80° C. and the achievement of a relative temperature index (RTI) of >+105° C. are worth mentioning. Comparable values cannot be achieved with monofilms.

The method of extrusion or lamination is best employed for producing the multilayer backsheet 1 for photovoltaic modules in accordance with the invention. If cross-linking of the polyamide is to be achieved, a cross-linking activator is added to the polyamide molding compound prior to shaping. Preferred cross-linking activators are for example TMPTMA (=trimethylol propane trimethacrylate) and TAIC (=triallyl isocyanurate). In the case of a respective activator, the cross-linking can already be performed during compounding or film extrusion in-line in a radical manner. Preferably, cross-linking is triggered subsequently in the extruded film by high-energy radiation. High-energy radiation preferably occurs by electron radiation.

The backsheet of the composition in accordance with the invention which is thus produced is used for the production of photovoltaic modules.

The variants with the cross-linked polyamide 11 and the polyamide 910 (uncross-linked and cross-linked), the polyamide 1010 (uncross-linked and cross-linked), the polyamide 1010/10CHDA (uncross-linked and cross-linked), the polyamide 1012 (uncross-linked and cross-linked) and the polyamide 1210 (uncross-linked and cross-linked) can moreover assert the ecological argument that they are based on sustainable raw materials because castor oil is not only the starting bases for producing the PA11 monomer but also for sebacic acid (decanedioic acid) and decandiamine which are used for the synthesis of polyamide with the 10C-diacid and/or the 10C-diamine. Moreover, azelaic acid (i.e. the C9-diacid) is accessible from castor oil which occurs in PA 99 or PA (M and/or P)ACM9. Preferably, the first embodiment of the laminated multilayer backsheet 1 for photovoltaic modules as shown in FIG. 1 comprises two outside layers 2, 3 made of a cross-linked polyamide PA 1010 and an inside layered 4 made of PVDC.

FIG. 2 also shows a multilayer backsheet 1 for photovoltaic modules which comprises a first outside layer 2, a second outside layer 3 and at least one inside layer 4 arranged between these outside layers 2, 3 and forming a water-vapor barrier and/or an oxygen barrier, with these layers being made of polymers. All statements made in connection with FIG. 1 also apply here too. Preferably, the second embodiment of the co-extruded multilayer backsheet 1 for photovoltaic modules as shown in FIG. 2 comprises two outside layers 2, 3 made of a polyamide PA MACM12 and one inside layer 4 made of COC functionalized with maleic anhydride.

FIG. 3 shows a multilayer backsheet 1 for photovoltaic modules with two outside layers 2, 3 and two inside layers 4, 5 according to a third embodiment. These two inside layers 4, 5 form a water-vapor barrier and/or oxygen barrier. All these layers are composed of polymers. All statements made in connection with FIG. 1 also apply analogously in this case too. However, one of the two inside layers 4, 5 can be made of EVOH. Preferably, the third embodiment of the laminated multilayer backsheet 1 for photovoltaic modules as shown in FIG. 3 comprises two outside layers 2, 3 made of a polyamide PA MACM 12, an inside layer 4 made of PVDC and an inside layer 5 made of EVOH.

FIG. 4 also shows a multilayer backsheet 1 for photovoltaic modules with two outside layers 2, 3 and two inside layers 4, 5 which are arranged between these outside layers 2, 3 and form a water-vapor barrier and/or oxygen barrier. All statements made in connection with FIG. 3 also apply in this case too. Preferably, the fourth embodiment of the laminated multilayer backsheet 1 for photovoltaic modules as shown in FIG. 4 comprises two outside layers 2, 3 made of a cross-linked polyamide PA 1010, an inside layer 4 made of PVDC and an inside layer 5 made of COC.

FIG. 5 also shows a multilayer backsheet 1 for photovoltaic modules with two outside layers 2, 3 and two inside layers 4, 5 which are arranged between these outside layers 2, 3 and form a water-vapor barrier and/or oxygen barrier. All statements made in connection with FIG. 3 also apply in this case too. Preferably, the fifth embodiment of the co-extruded multilayer backsheet 1 for photovoltaic modules as shown in FIG. 5 comprises two outside layers 2, 3 made of a cross-linked polyamide PA MACM12, an inside layer 4 made of COC and an inside layer 5 made of EVOH.

FIG. 6 shows a multilayer backsheet 1 for photovoltaic modules with two outside layers 2, 3 and three inside layers 4, 5, 8 which are arranged between these outside layers 2, 3 and form a water-vapor barrier and/or oxygen barrier. All these layers are composed of polymers. All statements made in connection with FIG. 1 or 3 also apply analogously in this case too. In this case, the multilayer backsheet 1 for photovoltaic modules comprises at least three inside layers 4, 5, 8. Barrier polymers which can be used as the second or third inside layers 5, 8 are PPA (polyphthalamide, partly aromatic polyamide), PPS (polyphenylene sulfide), PSU (polysulfone), PESU (polyether sulfone), PPSU (polyphenyl sulfone), PEI (polyetherimide), PAI (polyamideimide), PI (polyimide) and PEEK (polyether ether ketone).

The remaining components of the photovoltaic module (respectively not shown) are disposed in all drawings on the uppermost illustrated outside layer 2. In the case of two or three inside layers, the sequence of the barrier layers can be chosen differently than is shown in the drawings.

Alternative embodiments of the multilayer backsheet 1 for photovoltaic modules in accordance with the invention comprise the following examples as shown in Table 1, which examples merely represent a selection of preferred layer combinations and shall not be understood in any way as limiting:

TABLE 1

| AS 2 | HV | IS 4 | HV | IS 5 | HV | AS 3 |
|---|---|---|---|---|---|---|
| PA 12 | + | PVDC | | | + | PA 12 |
| PA 12 | + | EVOH | | | + | PA 12 |
| PA 12 | + | COC | | | + | PA 12 |
| PA 12 | + | PVDC | + | EVOH | + | PA 12 |
| PA 12 | + | COC | + | EVOH | + | PA 12 |
| PA 12 | + | EVOH | + | PP | + | PA 12 |
| PA 1010 | + | PVDC | | | + | PA 1010 |
| PA 1010 | + | EVOH | | | + | PA 1010 |
| PA 1010 | + | COC | | | + | PA 1010 |
| PA 1010 | + | PVDC | + | EVOH | + | PA 1010 |
| PA 1010 | + | COC | + | EVOH | + | PA 1010 |
| PA 1010 | + | PVDC | + | EVOH | + | PA 12 |
| PA 1010 | + | COC | + | EVOH | + | PA 12 |
| PA MACM12 | + | PVDC | | | + | PA MACM12 |
| PA MACM12 | + | EVOH | | | + | PA MACM12 |
| PA MACM12 | + | COC | | | + | PA MACM12 |
| PA MACM12 | + | PVDC | + | EVOH | + | PA MACM12 |
| PA MACM12 | + | COC | + | EVOH | + | PA MACM12 |

The abbreviations mean the following:
AS = Outside layer; HV = Adhesion promoter layer; IS = Inside layer

A number of selected standardized permeation values are stated as examples in the following Table 2 for the materials listed in Table 1:

TABLE 2

| | Oxygen permeability | | Water-vapor permeability | |
|---|---|---|---|---|
| | [cm³*mm/m²*day*bar] | | [g*mm/m²*day] | |
| Name of material | at 23° C./85% humidity | | at 23° C./85% humidity | |
| Polyamide 12 | 19 | [1] | 8 | [1] |
| (Grilamid L20) | | | | |
| PA MACM12 | 30 | [1] | 13 | [1] |
| (Grilamid TR 90) | | | | |
| EVOH | 0.05 | [2] | 0.8 | [2] |
| (EVAL EF-F) | | | | |
| PVDC | 0.31 | [2] | 0.02 | [2] |
| (Saran 100 HB) | | | | |
| COC | 71 | [2] | 0.03 | [2] |
| (Ticona Topas) | | | | |
| Polypropylene | 110 | [2] | 0.4 | [2] |
| (PP) | | | | |

Legend:
[1] Values measured internally by EMS under DIN/ISO 15105-1 (O₂) and DIN/ISO 15106-1 (H₂O)
[2] Values from literature: Permeability Properties of Plastics and Elastomers, Liesl K. Massey, 2003, Plastics Design Library.

The following exemplary permeabilities are calculated from the permeation values in Table 2. In order to enable stating the current permeation for a monofilm, the standardized permeation values are divided by the current layer thickness (in mm). In the case of multilayer films it is necessary to regard the reciprocal value of the individual permeation in every single layer (in analogy to electric resistance). In order to calculate the total permeation it is necessary to add up the reciprocal values of the individual permeations, and the reciprocal value is then calculated from this sum total (in analogy to the current flow through a series connection of electric resistors).

### Comparative Example: Monofilm

### Material: PA 12

Total thickness: 300 μm
Oxygen permeability: 63.3 [cm³/m²*day*bar],
Water-vapor permeability: 26.7 [g/m²*day]
Example: Multilayer film
Materials: PA 12 (125 μm)/PVDC (50 μm)/PA 12 (125 μm)
Total thickness: 300 μm
Oxygen permeability: 5.7 [cm³/m²*day*bar]
Water-vapor permeability: 0.40 [g/m²*day]
(The adhesion promoter layers are not considered here)

The comparison of the monofilm (comparative example) with a multilayer film (example) in accordance with the invention which has the same thickness shows the drastic level to which permeation can be reduced with the barrier film on the basis of the calculated permeabilities. In actual fact, the oxygen permeability is reduced in comparison with the comparative example by an approximate factor of 11 and the water-vapor permeability is reduced by an approximate factor of 66 in comparison with the comparative example.

It was not obvious to the person skilled in the art to apply the barrier materials which are rather known from food packaging technology to this entirely special technical field of the present invention, especially due to the materials (e.g. PVDC) which are partly difficult to process.

It applies generally that the outer layers 2, 3 can alternatively also be made of different preferred polyamides.

### LIST OF REFERENCE NUMERALS

1 Multilayer backsheet for photovoltaic modules
2 First outside layer
3 Second outside layer
4 First inside layer
5 Second inside layer
6 Outside adhesion promoter layer
7 First inside adhesion promoter layer
8 Third inside layer
9 Second inside adhesion promoter layer

1. A multilayer backsheet (1) for a photovoltaic module, comprising a first outside layer (2), a second outside layer (3) and at least one inside layer (4, 5) which is arranged between these outside layers (2, 3) and forms a water-vapor barrier and/or oxygen barrier, with these layers (2, 3, 4, 5) being composed of polymers, characterized in that at least one of the two outside layers (2, 3) comprises a polyamide, and that the at least one inside layer (4, 5) consists of polymers which are no fluoropolymers and do not comprise any polyethylene, wherein inside layers (4, 5) made of partly aromatic polyesters are connected by means of at least one outer adhesion promoter layer (6) made of block copolyesteramide with at least one of the outside layers (2, 3) comprising a polyamide.

2. A multilayer backsheet (1) for a photovoltaic module according to claim 1, characterized in that the two outsides layers (2, 3) of the multilayer backsheet (1) for a photovoltaic module consist of a polyamide, preferably the same polyamide.

3. A multilayer backsheet (1) for a photovoltaic module according to claim 2, characterized in that the polyamides for the at least one outside layer (2, 3) or both outside layers (2, 3) are composed on the basis of linear and/or branched aliphatic and/or cycloaliphatic and/or aromatic monomers which are chosen from the group of diamines, dicarboxylic acids, lactams and amino carboxylic acids.

4. A multilayer backsheet (1) for a photovoltaic module according to claim 1, characterized in that the polyamide of at least one or both outside layers (2, 3) is chosen from the group which comprises PA 12, PA 11, PA 610, PA 612, PA 1010, PA 1012 and PA MACM12, as well as their mixtures.

5. A multilayer backsheet (1) for a photovoltaic module according to claim 1, characterized in that the material for the at least one inside layer (4, 5) is chosen from a group which comprises PVDC, COC, PP, EVOH, PPS, PSU, PESU, PPSU, PEEK, LCP, PI and PAI, with the COC preferably been functionalized with maleic anhydride.

6. A multilayer backsheet (1) for a photovoltaic module according to claim 1, characterized in that it comprises at least two or three inside layers (4,5,8), with one inside layer (4, 5) consisting of EVOH and the second one preferably of PVDC in the case of at least two inside layers.

7. A multilayer backsheet (1) for a photovoltaic module according to claim 1, characterized in that an outer adhesion promoter layer (6) is arranged between at least one surface of an inside layer (4, 5, 8) and an inner surface of one of the two outside layers (2,3).

8. A multilayer backsheet (1) for a photovoltaic module according to claim 6, characterized in that an inside adhesion promoter layer (7, 9) is arranged between one surface each of a first inside layer (4), second inside layer (5) and/or third inside layer (8).

9. A multilayer backsheet (1) for a photovoltaic module according to claim 7, characterized in that the material for the adhesion promoter layers (6, 7, 9) is chosen from the group which comprises acrylates, epoxides, polyurethane (PUR), functionalized polyolefins, ionomers and ethylene vinyl acetate (EVA).

10. A multilayer backsheet (1) for a photovoltaic module according to claim 1, characterized in that the material for the at least one inside layer (4, 5) is chosen from a group of partly aromatic polyesters which comprises PBT, PET and PEN, with the adjacent outer adhesion promoter layer (6) made of block copolyesteramide having blocks compatible to layers (2, 3, 4, 5) adjacent to said adhesion promoter layer.

11. A multilayer backsheet (1) for a photovoltaic module according to claim 10, characterized in that the blocks of the outer adhesion promoter layer (6) made of block copolyesteramide correspond to the partly aromatic polyester of the inside layer (4, 5) and the polyamide of the outside layer (2, 3), on which the outer adhesion promoter layer (6) made of block copolyesteramide borders.

12. A multilayer backsheet (1) for a photovoltaic module according to claim 10, characterized in that it comprises an inside layer (4) made of a partly aromatic polyester which is connected on both sides by one outer adhesion promoter layer (6) each made of block copolyesteramide with two outside layers (2, 3) made of polyamide.

13. A multilayer backsheet (1) for a photovoltaic module according to claim 10, characterized in that multilayer backsheet (1) for a photovoltaic module is co-extruded.

14. A multilayer backsheet (1) for a photovoltaic module according to claim 1, characterized in that the polyamides of one or both outside layers (2, 3) contain at least one additive which is chosen from a group which consists of white pigments, UV stabilizers, UV absorbers, antioxidant agents, heat stabilizers, hydrolysis stabilizers, cross-linking activators, flame retardants, layered silicates, fillers, colorants, reinforcing agents, adhesion promoters and impact modifiers.

15. A multilayer backsheet (1) for a photovoltaic module according to claim 1, characterized in that it contains a white pigment and has a reflectivity of at least 92%, with the white pigment preferably being titanium dioxide.

16. A multilayer backsheet (1) for a photovoltaic module according to claim 1, characterized in that the polymers or polyamides of the outside layers (2, 3) consist of cross-linked polyamides, with cross-linked PA 1010 and cross-linked PA 12 being preferred materials.

17. A method for producing a multilayer backsheet (1) for a photovoltaic module, comprising a first outside layer (2) and a second outside layer (3) and at least one inside layer (4, 5) which is arranged between these outside layers (2, 3) and forms a water-vapor barrier and/or oxygen barrier, characterized in that at least one of the two outsides layers (2, 3) is formed by a polyamide, and that the at least one inside layer (4, 5) is formed by a polymer which is no fluoropolymer and does not comprise any polyethylene, wherein inside layers (4, 5) made of partly aromatic polyesters are used only in combination with an outer adhesion promoter layer (6) made of block copolyesteramide.

18. A method for producing a multilayer backsheet (1) for a photovoltaic module according to claim 17, characterized in that the two outsides layers (2, 3) are extruded from one polyamide molding compound each and are co-extruded or laminated onto the at least one inside layer (4, 5), optionally by using adhesion promoter layers.

19. A method for producing a multilayer backsheet (1) for a photovoltaic module according to claim 17, characterized in that it is formed by two outside layers (2, 3) and at least two inside layers (4, 5), with one of the inside layers being formed by EVOH and the second preferably by PVDC.

20. A method for producing a multilayer backsheet (1) for a photovoltaic module according to claim 17, characterized in that at least one of the two outsides layers (2, 3) is laminated onto an inside layer (4) made of PVDC, optionally by using adhesion promoter layers.

21. A method for producing a multilayer backsheet (1) for a photovoltaic module according to claim 17, characterized in that at least one of the two outsides layers (2, 3) is co-extruded or laminated onto an inside layer (4) made of COC or EVOH, optionally by using adhesion promoter layers.

22. A method for producing a multilayer backsheet (1) for a photovoltaic module according to claim 17, characterized in that the multilayer backsheet (1) for a photovoltaic module is produced by means of co-extrusion, with one inside layer (4) made of a partly aromatic polyester being connected on both sides in each case by way of one outside adhesion promoter layer (6) each made of block copolyesteramide with two outside layers (2, 3) made of polyamide.

23. A method for producing a multilayer backsheet (1) for a photovoltaic module according to claim 17, characterized in that a cross-linking activator is added a polyamide melt for the outside layers (2, 3) in order to achieve cross-linking of the polyamide.

24. A method for producing a multilayer backsheet (1) for a photovoltaic module according to claim 17, characterized in that the two outsides layers (2, 3) are extruded as films and cross-linking in the extruded films is triggered by high-energy radiation, preferably by electron radiation.

25. A method for producing a multilayer backsheet (1) for a photovoltaic module according to claim 23, characterized in that the cross-linking activator is chosen from the group of trimethylol propane trimethacrylate and triallyl isocyanurate.

26. The use of a backsheet (1) for a photovoltaic module according to claim 1.

27. The use of a method for its production according to claim 17 in the production of photovoltaic modules.
